(19) United States
(12) Patent Application Publication
(10) Pub. No.: US 2017/0269017 A1
(43) Pub. Date: Sep. 21, 2017

(54) Inflatable Bladder Based Mechanical Testing for Stretchable Electronics

(71) Applicant: Intel Corporation, Santa Clara, CA (US)

(72) Inventors: Steven A. KLEIN, Chandler, AZ (US); Rajendra C. DIAS, Phoenix, AZ (US); David C. MCCOY, Phoenix, AZ (US); Lars D. SKOGLUND, Chandler, AZ (US); Vijay SUBRAMANIAN, Gilber, AZ (US); Aleksander ALEKSOV, Chandler, AZ (US); Pramod MALATKAR, Chandler, AZ (US); Ravindranath V. MAHAJAN, Chandler, AZ (US); Robert L. SANKMAN, Phoenix, AZ (US)

(21) Appl. No.: 15/075,083

(22) Filed: Mar. 18, 2016

(51) Int. Cl. G01N 27/20

(52) U.S. Cl. CPC G01N 27/20

(57) ABSTRACT

Embodiments are generally directed to air bladder based mechanical testing for stretchable electronics. An embodiment of a system includes an inflatable bladder to apply mechanical force to a stretchable electronics device by the inflation and deflation of the inflatable bladder; a valve unit to control fluid pressure applied to the inflatable bladder; and a control unit to control inflation and deflation of the inflatable bladder.

### TECHNICAL FIELD

Embodiments described herein generally relate to the field of electronic devices and, more particularly, to inflatable bladder based mechanical testing for stretchable electronics.

### BACKGROUND

Stretchable electronics, in which electronic circuits are deposited on stretchable substrates or embedded in stretchable materials, have the potential to be utilized in many new types of devices, including wearable devices and other implementations.

The stretching of stretchable electronics will inevitably stress the electronic elements to some degree, and may cause device failure over time. As new uses for stretchable electronics are being developed, it is becoming increasing important to provide repeatable testing of the stretchable electronics under appropriate conditions in order to fully understand the mechanical capability and reliability risks for stretchable electronic devices.

However, testing of stretchable electronics is generally not standardized, and thus it is difficult to properly evaluate materials and devices that contain stretchable electronics.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a stretchable electronics testing system including an inflatable bladder according to an embodiment;

FIG. 2 is an illustration of a stretchable electronics testing system including an inflatable bladder according to an embodiment;

FIG. 3 is an illustration of electrical testing provided in conjunction with mechanical testing of stretchable electronics according to an embodiment;

FIG. 4 is an illustration of a measurement of mechanical forces applied to stretchable electronics in a mechanical test according to an embodiment;

FIG. 5 is an illustration of test settings for a mechanical test of stretchable electronics according to an embodiment; and

FIG. 6 is a flowchart to illustrate inflatable bladder based mechanical testing of stretchable electronics according to an embodiment.

### DETAILED DESCRIPTION

Embodiments described herein are generally directed to air bladder based mechanical testing stretchable electronics.

For the purposes of this description, the following apply:

“Stretchable electronics” or “elastic electronics” means electronic circuits that are deposited on stretchable substrates or embedded into stretchable materials, wherein the stretchable substrates and stretchable materials may include, but are not limited to, silicones, polyurethanes, and polymers. The electronic circuits may include stretchable electronic devices. Stretchable electronics may include, but are not limited to, circuits embedded in wearable devices.

“Wearable device”, “wearable electronic device”, or “wearable” refers in general to clothing and accessories that incorporate electronic devices. A wearable device may include stretchable electronics.

“Bladder” or “inflatable bladder” refers to non-permeable sac or other similar apparatus of any shape that is composed of a stretchable material such that the bladder increases in size as the bladder is filled with a fluid (a gas or liquid). A bladder to be filled by gas may also be referred to as an “air bladder”. A bladder may be constructed of a material such as rubber, but embodiments are not limited to any particular material.

In some embodiments, an apparatus, system, or method provides for mechanical testing of a stretchable electronics, in which mechanical forces are applied to a device under test to evaluate whether one or more failure conditions occur. In some embodiments, an apparatus, system, or method provides for an inflatable bladder based mechanical testing standard for stretchable electronics.

In some embodiments, an apparatus or system includes an inflatable bladder, such as a rubber bladder, to apply mechanical force in mechanical testing of stretchable electronics. In some embodiments, a stretchable electronics device under test is attached to an inflatable bladder for testing of the electronics in the device, and the bladder is inflated by the addition of fluid (gas or liquid) under pressure to the bladder in order to expand the size of the bladder, and thus provide mechanical force in multiple directions on the device under test. The mechanical force may include applying specified levels of one or more of stress, strain, and displacement of the device under test.

In some embodiments, the attachment of a device under test to an inflatable bladder includes one of multiple processes to provide attachment and minimize slippage. In one implementation, the device under test may be attached using a rubber or elastic band attachment.

In some embodiments, mechanical testing using an inflatable bladder includes measurement of an amount of expansion of the bladder in one or more direction to determine the amount of mechanical strain being applied, such as in terms of a percentage of expansion of the size of the stretchable electronics. In some embodiments, the measurement may be determined automatically utilizing an optical or mechanical measurement system.

In some embodiments, failure conditions for a stretchable electronics device under test may include multiple factors, including, but not limited to, delamination of electronics, bulk fracture of circuit, or cracking of traces (resulting in, for example, a change in electrical resistance as open or partially open circuit connection is created).

In some embodiments, mechanical testing includes multiple inflation and deflation cycles to provide repeated forces on the device under test. In some embodiments, the testing further includes the addition of one or more environmental factors, such as temperature, humidity, and salinity (salt water testing to simulate sweat), to simulate conditions for the device under test in use, including use when in contact with or near to human skin. In some embodiments, the mechanical testing may include testing within a chamber, where, for example, temperature and other conditions may be adjusted to mimic use conditions and for accelerated temperature cycling testing. In some embodiments, the conditions being mimicked may include conditions for a patch that is on a human body, conditions for a bracelet or other wearable under daily temperature changes, and other such conditions.

In some embodiments, mechanical testing may further include testing utilizing a controlled temperature of a fluid to inflate the inflatable bladder. In some embodiments, the mechanical testing may include adjusting the fluid temperature to mimic surface temperatures that may be encountered by a device under test.

In some embodiments, testing include multi-lateral testing in which a device under test is subject to stress in multiple directions, including more specifically bilateral testing in which forces are applied both in an X-direction and a Y-direction. In some embodiments, multi-lateral testing may include application of stress in multiple directions simultaneously or may include application of stress in directions sequentially, as required to fully evaluate effects on the stretchable electronics of a device under test.

In some embodiments, an apparatus or system includes an inflatable bladder with an input air (or liquid) pressure line which is controlled by a computer logic. In some embodiments, a control program allows the user to create a settings that control, for example, a number of inflation-deflation cycles, initial diameter of the inflatable bladder, a final diameter of the inflatable bladder, and a hold time of the bladder during which the bladder remains inflated. In this manner, a sample can receive mechanical cycling that is similar to the use conditions for the device. In some embodiments, the type of attachment of the device to the rubber bladder may simulate the type of attachment of the device to a person who is using the device (such as, for example, a chest patch, armband, wristband, clothing attachment, or other attachment). In some embodiments, an apparatus or system simulates expansion of the wearable devices as would occur on the human body, and thus provides a more realistic estimate of the type of mechanical damage that may occur to the samples in use.

In some embodiments, an apparatus or system includes electrical monitoring in-situ. In contrast to typical tensile testing of samples in lab scenarios, which may determine where bulk fracture occurs, electrical monitoring allows for detection of, for example, electrical opens in the traces of a device. In some embodiments, an apparatus or system is further operable to provide cyclic testing, which can detect types of damage to the device that are different than, for example, stretching a device sample to failure.

While the illustrations provided herein illustrate an inflatable bladder as being approximately spherical in shape, embodiments are not limited to a particular shape of bladder. Rather, an inflatable bladder may be any shape that provides needed mechanical forces on a stretchable electronics device for testing of such device. Other possible shapes include, but are not limited to, an oblong shape (such as roughly the shape of a football) or a cylindrical shape.

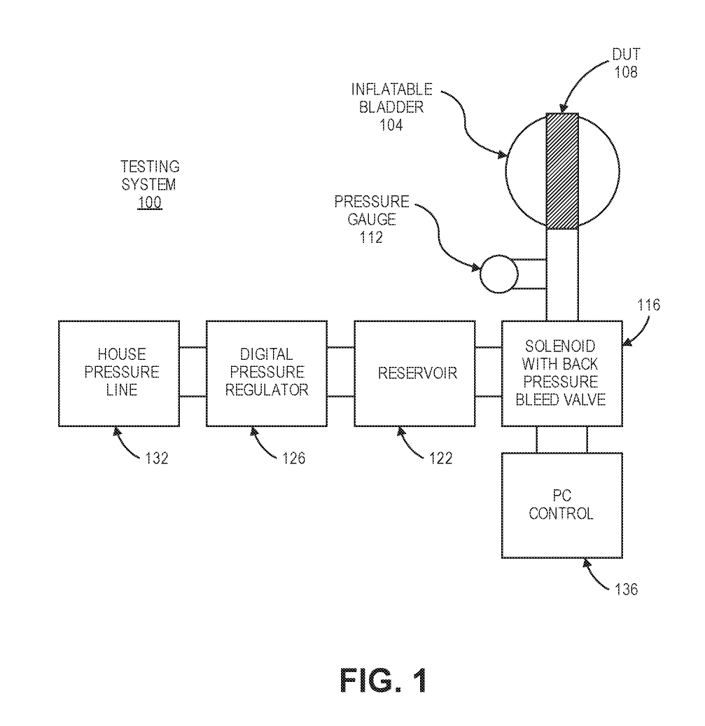

FIG. 1 is an illustration of a stretchable electronics testing system including an inflatable bladder according to an embodiment. In the high level diagram provided in FIG. 1, a testing system 100 includes an inflatable bladder 104 to which may be attached a stretchable electronics device under test (DUT) 108, wherein the device under test 108 is attached to the inflatable bladder 104 to apply mechanical force to the stretchable electronics of the device under test 108 as the inflatable bladder is inflated and deflated. While the device under test 108 is shown as a rectangular shape along a diameter of the inflatable bladder for purposes of illustration, this is only one example of a device for testing. In some embodiments, the device under test may be any shape and size that can be attached to the inflatable bladder for mechanical testing.

In some embodiments, the testing system may further include a pressure gauge (such as a digital pressure gauge) 112 to measure the air pressure in the inflatable bladder 104. In some embodiments, the system 100 includes a valve unit to control fluid pressure applied to the inflatable bladder, wherein the valve unit in this implementation is a solenoid with back pressure bleed valve 116 to allow pressure into the bladder and hold the pressure, and to allow release of pressure from the bladder, to thus inflate and deflate the air bladder. In other implementation, the solenoid may be replaced with a different valve unit to enable the addition and release of fluid pressure for the inflatable bladder 104.

In some embodiments, the system 100 includes a reservoir 122 to hold air under pressure for inflation of the inflatable bladder 112. In some embodiments, the system further includes a pressure regulator, such as a digital pressure regulator 126, to regulate the level of air pressure for the reservoir 122. In some embodiments, the pressure regulator 126 is coupled with a line, such as house pressure line 132 to provide pressurized air for inflation of the bladder 104, where the pressure line 132 may be coupled with a compressor (not shown in FIG. 1).

In some embodiments, the system includes a control unit, such as personal computer (PC) control 136, to control the testing process for the device under test 108, including the inflation an deflation cycles for the inflatable bladder 104 via control of the solenoid 116.

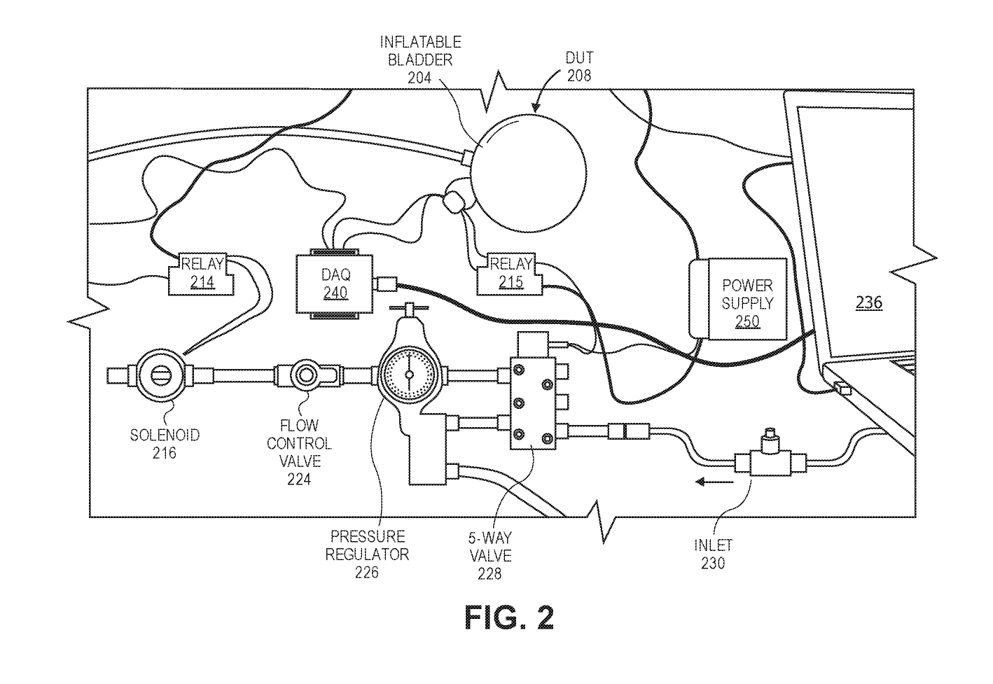

FIG. 2 is an illustration of a stretchable electronics testing system including an inflatable bladder according to an embodiment. In the specific implementation illustrated in FIG. 2, a testing system 200 includes:

(a) An inflatable bladder 204 to which may be attached a stretchable electronics device under test (DUT) 208, wherein the device under test 208 is attached to the inflatable bladder 204 to apply mechanical force to the stretchable electronics of the device under test 208 as the inflatable bladder is inflated and deflated. In this implementation, the bladder is an air bladder that is inflated with air.

(b) A valve unit such a solenoid (with back pressure bleed valve) 216 to allow pressure into the bladder and hold the pressure, and to allow release of pressure from the bladder, to thus inflate and deflate the air bladder.

(c) A first relay 214 to control the operation of the solenoid 214.

(d) A data acquisition unit (DAQ) 240 to acquire data regarding the device under test 208, such as in measuring one or more resistances or other electrical values for the device under test 208 as the inflatable bladder 204 is inflated.

(e) A second relay 215.

(f) A flow control valve 224 to connect or disconnect air pressure to the solenoid 216.

(g) A pressure regulator 226 to regulate the level of air pressure.

(h) A valve (a 5-way valve) 228 to connect air pressure via an inlet 230 to the pressure regulator 226.

(i) A computer or other control unit including control software 236, such as Labview, to control operation of the testing system, including the inflation and deflation cycles for the inflatable bladder 204 via control of the solenoid 216.

(j) A power supply 250 to provide power for elements of the system 200.

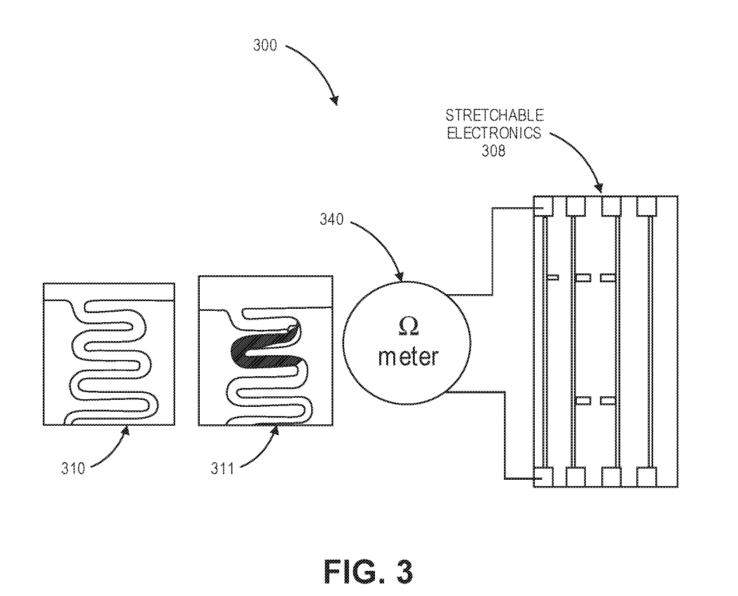

FIG. 3 is an illustration of electrical testing provided in conjunction with mechanical testing of stretchable electronics according to an embodiment. In some embodiments, a test operation 300 for stretchable electronics 330, such as the device under test 108 illustrated in FIG. 1 or the device under test 208 illustrated in FIG. 2, includes, but is not limited to, testing of one or more electrical values for the stretchable electronics 308 as the electronics are subjected to mechanical force, such as mechanical force induced by the inflation and deflation of the inflatable bladder 104 illustrated in FIG. 1 or the inflatable bladder 204 illustrated in FIG. 2. The electrical testing is provided to determine onset of failure of the stretchable electronics as a result of the mechanical force applied by the testing. The electrical testing may include, but is not limited to, measurement of resistance change. In some embodiments, the electrical testing may be combined with the mechanical testing illustrated in FIG. 1.

In a particular implementation, the mechanical testing of stretchable electronics may affect a trace section 310 such that a least a portion of the trace section lifts away 311. Because of this affect, the electrical resistance of the trace may change, wherein the change may result in an infinite resistance at an extreme but also result in simply a higher than normal resistance in other cases. Further, in additional to any permanent change in resistance, a temporary or sporadic change may occur, such as only while a force is applied to the stretchable electronics 308. In some embodiments, the testing may include application of an ohmmeter to measure resistance, where such measurement may be made constantly or at certain sample points to allow detection of temporary or sporadic changes in resistance.

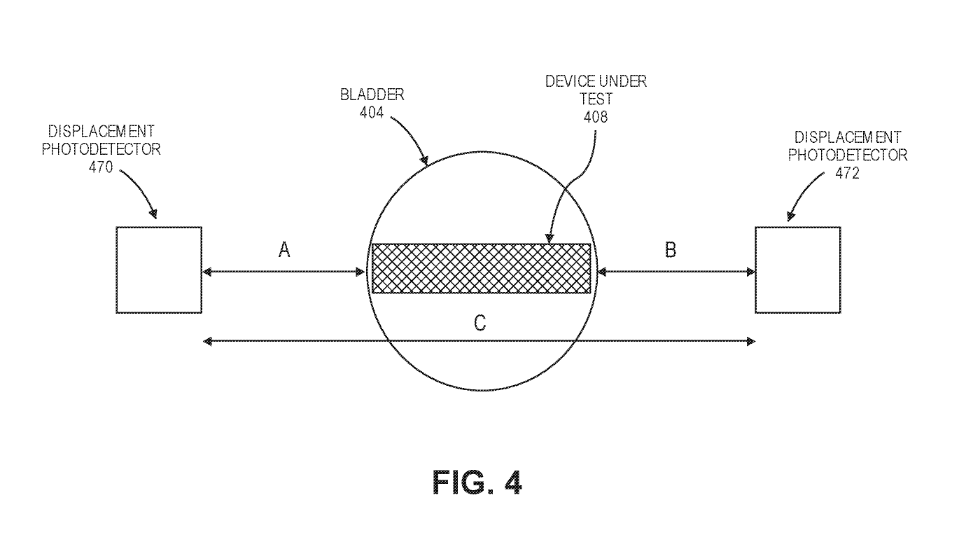

FIG. 4 is an illustration of a measurement of mechanical force applied to stretchable electronics in a mechanical test according to an embodiment. In some embodiments, an inflatable bladder 404 is utilized in mechanical testing of a stretchable electronics device under test 408, including, for example testing in a system as illustrated in FIG. 1 or FIG. 2. In some embodiments, the mechanical force applied to the electronics of the device under test 408 may be determined by one or more measurement units. In some embodiments, mechanical force may be determined by measuring a change in size of the inflatable bladder, such as force being determined as a function of a difference between a diameter of the bladder at a first pressure level for the inflatable bladder 404 (such as when a minimal amount of pressure is present and no mechanical force is applied) and the diameter at a second, higher pressure level. In this example, the length of the stretchable electronics increases linearly with the circumference of the bladder, or 7C times the diameter of the bladder.

In some embodiments, the diameter (or other physical measurement) of the bladder 404 is determined automatically, such as an automatic determination based on light reflection time utilizing one or more displacement photodetectors. In the illustrated implementation, a diameter of the bladder is equal to a distance C between a first displacement photodetector 470 and a second displacement photodetector 472, minus a first distance A between the first displacement photodetector 470 a first side of the bladder 404 and minus a second distance B between the second displacement photodetector 472 and a second, opposite side of the bladder 404. As a equation:

Diameter=C−A−B [1]

FIG. 4 provides a particular measurement system, but embodiments are not limited to this particular implementation. In some embodiments, measurement of mechanical force may include alternative measurement technologies, including, but not limited to, the following:

(1) A strain gauge may be employed around or integrated into the inflatable bladder. The strain gauge changes, for example, electrical resistance in a pre-determined way with applied strain and thus the diameter change of the bladder can be determined from measurements of the strain gauge.

(2) Digital image correlation may be utilized, wherein a camera and lens system tracks the displacement or strain of the sample in a non-contact manner. The digital image correlation may be utilized to provide real time measurement of mechanical force applied to the device under test.

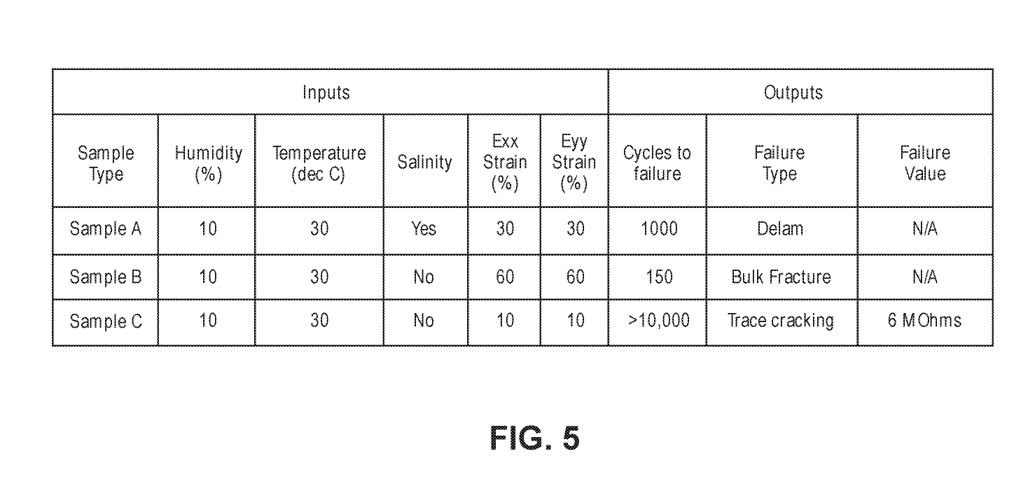

FIG. 5 is an illustration of test settings for a mechanical test of stretchable electronics according to an embodiment. In some embodiments, the testing may include testing using the system illustrated in FIG. 1 or as illustrated in FIG. 2. While particular examples of testing for three samples are illustrated in FIG. 5, embodiments are not limited to the illustrated inputs and outputs, or to particular settings for each test.

In some embodiments, testing inputs for each of a plurality of samples may include, but are not limited to, a humidity level (as a percentage); a temperature level (as degrees Celsius); salinity (such as whether a certain amount of salt is or is not added); strain in a first direction (such as in terms of a percentage of a length in a first direction, E_{XX} strain) and strain in a second direction (such as in terms of a percentage of a length in a second direction, E_{YY} strain). Strain may also be measured directly using a strain gauge.

Other examples include ultraviolet testing to determine effect on cyclic testing, or damage resulting as a result from extended time at a set strain value (with humidity and temperature as variables as well).

In some embodiments, testing outputs for each of a plurality of samples may include a number of cycles to failure (such as a certain number of inflation and deflation cycles for a particular set of test input settings); a particular failure type (such as, for example, delamination of the stretchable electronics occurring within a certain number of cycles; bulk fracture of stretchable electronics occurring within a certain number of cycles; or trace cracking within any number of cycles); and a failure value (such as a certain electrical resistance value that is indicative of a trace cracking condition).

In some embodiments, the detection of a failure condition may include, but is not limited to, the following:

(1) Trace (metal) cracking: Trace cracking may be determined with an electrical resistance test, as resistance is expected to change as traces are damaged. In some embodiments, trace cracking may also include more complicated electrical testing, such as parametric testing and functional testing of stretchable electronics.

(2) Delamination: In some embodiments, for optically transparent materials testing for delamination may include can use optical imaging or photoelastic testing processes. In some embodiments, for non-transparent materials, delamination may detected using, for example, an acoustic sensor to identify areas of delamination

(3) Bulk fracture: In some embodiments, bulk fracture testing may utilize electrical testing, such as described stated above. In some embodiments, bulk fracture may also be detected utilizing a contact sensor (load cell/contact pressure sensor), which can determine if a sample is still in contact with the bladder.

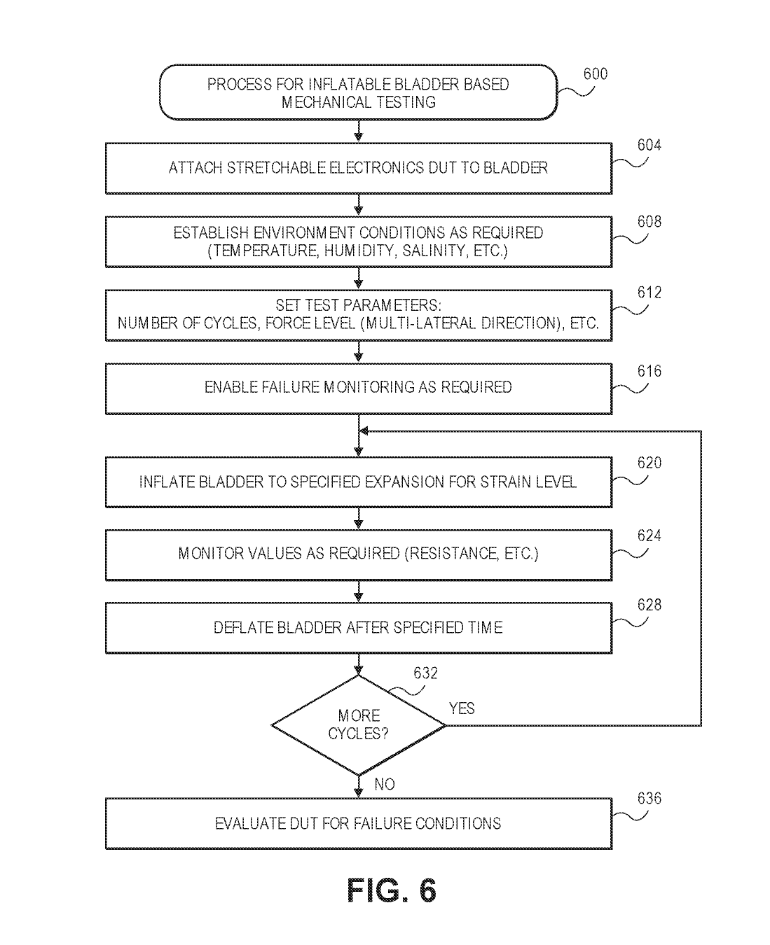

FIG. 6 is a flowchart to illustrate inflatable bladder based mechanical testing of stretchable electronics according to an embodiment. In some embodiments, a process 600 for inflatable bladder based mechanical testing of stretchable electronics includes:

604: Attach a stretchable electronics device under test to an inflatable bladder of a testing system.

608: Establish environmental conditions as required for the mechanical testing, which includes, but is not limited to, establishing required conditions for temperature, humidity, and salinity, such as illustrated in FIG. 5.

612: Set test parameters, where such test parameters may include, but are not limited to, number of inflation-deflation cycles for the inflatable bladder, and mechanical force level. In some embodiments, testing may be multilateral testing, such as a first level of stress in a first direction and a second level of stress in a second direction.

616: Enable failure monitoring as required for testing, including, but not limited to, electrical testing providing monitoring of electrical conditions of the stretchable electronics during testing (such as monitoring a resistance utilizing an ohmmeter or measure any other electrical value of the stretchable electronics); strain gauge monitoring; or digital image correlation.

620: Commence a first cycle by inflating the inflatable bladder to a particular level to generate a certain mechanical force level. A determination of the mechanical force level may include, but is not limited to, bladder diameter measurement as illustrated in FIG. 5.

624: Monitor values for the stretchable electronics as required, such as a measurement as illustrated in FIG. 5.

628: Complete an inflation-deflation cycle by deflating the bladder after a certain amount of time;

632: Determine whether there are additional cycles to be performed in the particular test. If so, the process returns to inflating the bladder to perform another cycle.

634: If not, the testing cycles are complete, and the process may continue with evaluating the stretchable electronics device under test to determine whether there is any failure of the device, such as by delamination, trace crack, or bulk fracture of the stretchable electronics.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, a mechanical testing system includes an inflatable bladder to apply mechanical forces to a stretchable electronics device by the inflation and deflation of the inflatable bladder; a valve unit to control fluid pressure applied to the inflatable bladder; and a control unit to control inflation and deflation of the inflatable bladder.

In some embodiments, the system further includes a monitoring unit to monitor for a failure condition in the stretchable electronics device.

In some embodiments, the monitoring unit is to detect an electrical value of the stretchable electronics device. In some embodiments, the electrical value is an electrical resistance value.

In some embodiments, the system further includes a measurement unit to measure mechanical force on the stretchable electronics device. In some embodiments, the measurement unit is to measure a change in size of the inflatable bladder. In some embodiments, the measurement includes one or more photodetectors to detect one or more distances relating to the inflatable bladder.

In some embodiments, the system further includes a pressure regulator to regulate an amount of fluid pressure to be directed to the inflatable bladder.

In some embodiments, the control unit includes a computer with control software.

In some embodiments, the system further includes a chamber to provide control of environmental conditions for the stretchable electronics.

In some embodiments, the system further includes a temperature control unit to control a temperature of fluid for the inflation of the inflatable bladder.

In some embodiments, a method includes receiving test parameters for mechanical testing of a stretchable electronics device, the stretchable electronics device being coupled with an inflatable bladder, the test parameters including a specified level of mechanical force to be applied to the stretchable electronics device; performing one or more inflation and deflation cycles for the inflatable bladder based at least part on the test parameters, including inflating the inflatable bladder to the specified level of mechanical force; and monitoring for one or more failure conditions for the stretchable electronics device.

In some embodiments, the mechanical forces include one or more of stress, strain, or displacement.

In some embodiments, the test parameters further include a specified number of inflation and deflation cycles for testing of the stretchable electronics device.

In some embodiments, monitoring for one or more failure conditions includes monitoring one or more electrical values of the stretchable electronics device. In some embodiments, the one or more electrical values of the stretchable electronics device include an electrical resistance of the stretchable electronics device.

In some embodiments, the method further includes applying one or more environmental conditions for the mechanical testing of the stretchable electronics.

In some embodiments, the one or more environmental conditions include one or more of temperature, humidity, and salinity.

In some embodiments, the specified level of mechanical force includes multi-lateral stress, the multi-lateral stress including a first level of stress in a first direction and a second level of stress in a second direction.

In some embodiments, the one or more failure conditions include one or more of: trace cracking of the stretchable electronics device; delamination of the stretchable electronics device; or bulk fracture of the stretchable electronics device.

In some embodiments, a non-transitory computer-readable storage medium having stored thereon data representing sequences of instructions that, when executed by a processor, cause the processor to perform operations comprising: receiving test parameters for mechanical testing of a stretchable electronics device, the stretchable electronics device being coupled with an inflatable bladder, the test parameters including a specified level of mechanical force to be applied to the stretchable electronics device; performing one or more inflation and deflation cycles for the inflatable bladder based at least part on the test parameters, including inflating the inflatable bladder to the specified level of mechanical force; and monitoring for one or more failure conditions for the stretchable electronics device.

In some embodiments, an apparatus include means for receiving test parameters for mechanical testing of a stretchable electronics device, the stretchable electronics device being coupled with an inflatable bladder, the test parameters including a specified level of mechanical force to be applied to the stretchable electronics device; means for performing one or more inflation and deflation cycles for the inflatable bladder based at least part on the test parameters, including inflating the inflatable bladder to the specified level of mechanical force; and means for monitoring for one or more failure conditions for the stretchable electronics device.

1. A mechanical testing system comprising:
an inflatable bladder to apply mechanical forces to a stretchable electronics device by the inflation and deflation of the inflatable bladder;
a valve unit to control fluid pressure applied to the inflatable bladder; and
a control unit to control inflation and deflation of the inflatable bladder.

2. The system of claim 1, further comprising a monitoring unit to monitor for a failure condition in the stretchable electronics device.

3. The system of claim 2, wherein the monitoring unit is to detect an electrical value of the stretchable electronics device.

4. The system of claim 3, wherein the electrical value is an electrical resistance value.

5. The system of claim 1, further comprising a measurement unit to measure mechanical force on the stretchable electronics device.

6. The system of claim 5, wherein the measurement unit is to measure a change in size of the inflatable bladder.

7. The system of claim 6, wherein the measurement includes one or more photodetectors to detect one or more distances relating to the inflatable bladder.

8. The system of claim 1, further comprising a pressure regulator to regulate an amount of fluid pressure to be directed to the inflatable bladder.

9. The system of claim 1, wherein the control unit includes a computer with control software.

10. The system of claim 1, further comprising a chamber to provide control of environmental conditions for the stretchable electronics device.

11. The system of claim 1, further comprising a temperature control unit to control a temperature of fluid for the inflation of the inflatable bladder.

12. A method comprising:
receiving test parameters for mechanical testing of a stretchable electronics device, the stretchable electronics device being coupled with an inflatable bladder, the test parameters including a specified level of mechanical force to be applied to the stretchable electronics device;
performing one or more inflation and deflation cycles for the inflatable bladder based at least part on the test parameters, including inflating the inflatable bladder to the specified level of mechanical force; and
monitoring for one or more failure conditions for the stretchable electronics device.

13. The method of claim 12, wherein the mechanical forces include one or more of stress, strain, or displacement.

14. The method of claim 12, wherein the test parameters further include a specified number of inflation and deflation cycles for testing of the stretchable electronics device.

15. The method of claim 12, wherein monitoring for one or more failure conditions includes monitoring one or more electrical values of the stretchable electronics device.

16. The method of claim 15, wherein the one or more electrical values of the stretchable electronics device include an electrical resistance of the stretchable electronics device.

17. The method of claim 12, further comprising applying one or more environmental conditions for the mechanical testing of the stretchable electronics device.

18. The method of claim 17, wherein the one or more environmental conditions include one or more of temperature, humidity, and salinity.

19. The method of claim 12, wherein the specified level of mechanical force includes multi-lateral stress, the multi-lateral stress including a first level of stress in a first direction and a second level of stress in a second direction.

20. The method of claim 12, wherein the one or more failure conditions include one or more of:
trace cracking of the stretchable electronics device;
delamination of the stretchable electronics device; or
bulk fracture of the stretchable electronics device.

21. A non-transitory computer-readable storage medium having stored thereon data representing sequences of instructions that, when executed by a processor, cause the processor to perform operations comprising:
receiving test parameters for mechanical testing of a stretchable electronics device, the stretchable electronics device being coupled with an inflatable bladder, the test parameters including a specified level of mechanical force to be applied to the stretchable electronics device;
performing one or more inflation and deflation cycles for the inflatable bladder based at least part on the test parameters, including inflating the inflatable bladder to the specified level of mechanical force; and
monitoring for one or more failure conditions for the stretchable electronics device.

22. The medium of claim 21, wherein monitoring for one or more failure conditions includes monitoring one or more electrical values of the stretchable electronics device.

23. The medium of claim 22, wherein the one or more electrical values of the stretchable electronics device include an electrical resistance of the stretchable electronics device.
